(19) United States
(12) Patent Application Publication
(10) Pub. No.: US 2013/0129112 A1
(43) Pub. Date: May 23, 2013

(54) CONTENTS REPRODUCING SYSTEM, RECEIVING APPARATUS AND RECEIVING METHOD

(71) Applicant: Susumu TAKEMURA, Osaka (JP)

(72) Inventor: Susumu TAKEMURA, Osaka (JP)

(73) Assignee: Onkyo Corporation, Osaka (JP)

(21) Appl. No.: 13/459,292

(22) Filed: Apr. 30, 2012

(30) Foreign Application Priority Data
Nov. 17, 2011 (JP) 2011-252065

(51) Int. Cl. H04B 3/00; H04L 12/43

(52) U.S. Cl. 381/80; 370/458

(57) ABSTRACT

A transmitting apparatus transmits contents data of the same contents in the same reproducing positions to the respective receiving apparatuses at the same time. The receiving apparatuses specifies a reception start time at which contents data of next contents is first received, and adds a same delay time set in each of the receiving apparatuses to the reception start time so as to set a reproduction start time of next contents. The receiving apparatuses end the reproduction of the on-reproducing contents at the reproduction start time, and starts reproduction of the contents data of the next contents. Therefore, even when the reproducing positions slightly shift from each other among the receiving apparatuses during reproduction of the contents, the reproduction start times of the next contents can be synchronized with each other among all the receiving apparatuses.

### BACKGROUND OF THE INVENTION

1. Field of the Invention

The present invention relates to a contents reproducing system having a transmitting apparatus and a receiving apparatus.

2. Description of the Related Art

The following system is proposed. In this system, same contents data are transmitted from a transmitting apparatus via a network to a plurality of receiving apparatuses at the same time, so that all the same contents data are simultaneously reproduced by the respective receiving apparatuses. Variations of frequencies of reproducing clocks in the respective receiving apparatuses causes a larger gap of the contents reproducing positions in the receiving apparatuses according to continuous of the reproduction in the receiving apparatuses even when the transmitting apparatus transmits the same contents data to the receiving apparatuses. In order to solve this problem, US patent publication 2007/0038999 proposes a technology such that reproducing clocks of the receiving apparatuses are matched with each other based on a clock of a transmitting apparatus and time information added to packets. However, in this technology, hardware used for matching clocks (voltage-frequency conversion using VCXO, or a change in a division multiplying ratio of PLL) should be added.

### SUMMARY OF THE INVENTION

The present invention has been devised in order to solve the above conventional problem, and its object is to provide a contents reproducing system that can synchronize reproduction start times of respective contents in respective receiving apparatuses according to a software process.

It is another object of the present invention to provide a contents reproducing system that can synchronize reproduction start times of respective contents between receiving apparatuses and a transmitting apparatus according to a software process.

The present invention may solve any one of the above problems.

A contents reproducing system of a preferred embodiment for sequentially reproducing a plurality of contents, comprises: a transmitting apparatus; and a plurality of receiving apparatuses connectable with the transmitting apparatus via a network.

The transmitting apparatus has a transmitting section for transmitting contents data of same contents on a same reproducing position to the respective receiving apparatuses at a same time.

Each of the receiving apparatuses includes a receiving section for receiving the contents data from the transmitting apparatus, a reproducing section for reproducing the received contents data, a time specifying section for specifying a reception start time at which contents data of next contents is received first, a start time setting section for adding a delay time set to the same time in each of the receiving apparatuses to the reception start time, and setting a reproduction start time of next contents, a time determining section for determining whether the reproduction start time comes, and a reproduction controller for, when the determination is made that the reproduction start time comes, allowing the reproducing section to end the reproduction of the on-reproducing contents and start the reproduction of the contents data of the next contents in the reproduction start time.

The transmitting apparatus transmits contents data of the same contents in the same reproducing positions to the respective receiving apparatuses at the same time. Therefore, the respective receiving apparatuses receive the contents data of the same contents in the same reproducing positions at the approximately same time. Each of the receiving apparatuses specifies a reception start time at which contents data of next contents is first received, and adds a same delay time set in each of the receiving apparatuses to the reception start time so as to set a reproduction start time of next contents. When each of the receiving apparatuses ends the reproduction of the on-reproducing contents at the reproduction start time, and starts reproduction of the contents data of the next contents in the reproduction start time. Therefore, even when the reproducing positions slightly shift from each other among the receiving apparatuses during reproduction of the contents, the reproduction start times of the next contents can be synchronized with each other among all the receiving apparatuses.

Preferably, when the determination is made that the reproduction start time comes, the reproduction controller allows the reproducing section to delete all the contents data of the on-reproducing contents from a storage region and store the contents data of the next contents in the reproduction start time so as to start the reproduction of the contents data of the next contents in the reproduction start time.

When the contents data of the previous contents are still stored in a buffer at the reproduction start time of next contents, all the contents data of the previous contents are deleted, and contents data of next contents is stored in the buffer, so that the reproduction of the next contents can be started at the reproduction start time.

Preferably, the transmitting section transmits information representing fade-out or information representing fade-in together with the contents, the reproducing section carries out synthesizing and reproduction so that an end portion of the previous contents is faded out and a head portion of the next content is faded in, the start time setting section adds the delay time to the reception start time, and subtracts a residual reproduction time accumulated in the buffer at the time of first receiving the contents data of the next contents so as to set the reproduction start time.

When the previous contents are faded out and the next contents are faded in, the contents data of the previous contents remaining in the buffer cannot be deleted at the reproduction start time of the next contents. This is because a halfway portion of the previous contents is not reproduced. In this example, a residual reproduction time of the previous contents accumulated in the buffer at the first reception of the contents data of the next contents is subtract from the reproduction start time of the next contents, so that this problem can be solved.

Preferably, each of the respective receiving apparatuses further has a residual reproduction time transmitting section for transmitting a residual reproduction time of the on-reproducing contents at a time when the determination is made that the reproduction start time comes to the transmitting apparatus, the transmitting apparatus further has a residual reproduction time receiving section for receiving the residual reproduction times of the on-reproducing contents at a time when the determination is made that the reproduction start time comes from the respective receiving apparatuses, a delay time calculator for specifying maximum value of the residual reproduction times received from the respective receiving apparatuses and adds the maximum value to the delay time so as to calculate new delay time, and a delay time transmitting section for transmitting the calculated new delay time to the receiving apparatuses, respectively, each of the receiving apparatuses further has a delay time receiving section for receiving the calculated new delay time, the start time setting section adds the calculated new delay time to the reception start time, and sets a reproduction start time of next contents.

Each of the receiving apparatuses transmits a residual reproduction time of the on-reproducing contents at a time when the determination is made that the reproduction start time comes (namely, the residual reproduction time for which the reproduction is not carried out) to the transmitting apparatus. The transmitting apparatus specifies a maximum value of the residual reproduction time received from each of the receiving apparatuses and adds the maximum value to the delay time so as to calculate a new delay time, and transmits the new delay time to each of the receiving apparatuses. Each of the receiving apparatuses sets the reproduction start time using the new delay time. Therefore, the delay times can be suitably corrected so that all the receiving apparatuses can completely reproduce the contents.

Preferably, the plurality of contents is a continuous audio signal, each of the receiving apparatuses further has a difference information transmitting section for transmitting information about a difference between a reference clock received from the transmitting apparatus and a clock managed in each of the receiving apparatuses to the transmitting apparatus, the transmitting apparatus further has a difference information receiving section for receiving the difference information from each of the receiving apparatuses, and a contents separating section for, when the received difference information is a predetermined value or more and an audio signal level is less than a predetermined level at which the audio signal is determined as silent, separating the contents as another contents on a portion where the audio signal level is less than the predetermined level.

Even an audio signal where a plurality of contents continue is divided at a soundless portion so as to form another contents so that reproduction start times of another contents can be synchronized with each other among the receiving apparatuses.

A contents reproducing system of the other preferred embodiment for sequentially reproducing a plurality of contents, comprises: a transmitting apparatus; and a receiving apparatus connectable with the transmitting apparatus via a network.

The transmitting apparatus has a transmitting section for transmitting contents data of same contents on a same reproducing position to the receiving apparatus and the transmitting apparatus at a same time.

The receiving apparatus and the transmitting apparatus have a receiving section for receiving the contents data from the transmitting apparatus, a reproducing section for reproducing the received contents data, a time specifying section for specifying a reception start time at which contents data of next contents is received first, a start time setting section for adding a delay time set to the same time in each of the receiving apparatus and the transmitting apparatus to the reception start time so as to set a new reproduction start time of contents, a time determining section for determining whether the reproduction start time comes, and a reproduction controller for, when the determination is made that the reproduction start time comes, allowing the reproducing section to end the reproduction of the on-reproducing contents and start the reproduction of the contents data of the next contents in the reproduction start time.

The transmitting apparatus transmits contents data of the same contents in the same reproducing position at the same time to each of the receiving apparatuses and the transmitting apparatus itself. Therefore, each of the receiving apparatuses and the transmitting apparatus receive the contents data of the same contents in the same reproducing positions at the same time. Each of the receiving apparatuses and the transmitting apparatus specify reception start time at which contents data of next contents is first received, add a same delay time set in each of the receiving apparatuses and the transmitting apparatus to the reception start time, so as to set a reproduction start time of next contents. Each of the receiving apparatuses and the transmitting apparatus end the reproduction of the on-reproducing contents at the reproduction start time, and start the reproduction of the contents data of the next contents in the reproduction start time. Therefore, even when the reproducing positions are shifted from each other among the receiving apparatuses and the transmitting apparatus during the reproduction of contents, the reproduction start times of the next contents can be synchronized with each other among the receiving apparatuses and the transmitting apparatus.

### BRIEF DESCRIPTION OF THE DRAWINGS

FIG. 1 is a block diagram illustrating a contents reproducing system of the present invention;

FIG. 2 is a diagram illustrating a transmitting apparatus 100;

FIG. 3 is a diagram illustrating a receiving apparatus 200;

FIG. 4 is a diagram illustrating a queue management table;

FIG. 5 is a flowchart illustrating a transmitting process of the transmitting apparatus 100;

FIG. 6 is a flowchart illustrating a receiving process of the receiving apparatus 200;

FIG. 7 is a diagram illustrating transition of a queue state;

FIG. 8 is a flowchart illustrating a reproducing process of the receiving apparatus 200;

FIG. 9 is a flowchart illustrating a reproduction start waiting process of the receiving apparatus 200;

FIG. 10 is a pattern diagram illustrating reproduction of a previous music piece X and a next music piece Y in the respective receiving apparatuses 200;

FIG. 11 is a flowchart illustrating an on-reproducing process of the receiving apparatus 200;

FIG. 12 is a diagram illustrating fade-in and fade-out;

FIG. 13 is a diagram illustrating correction of a fade time according to a buffer residual time;

FIG. 14 is a sequence diagram illustrating a process of the transmitting apparatus 100 and the receiving apparatus at the time of the fade-in and the fade-out;

FIG. 15 is a flowchart illustrating the transmitting process of the transmitting apparatus 100;

FIG. 16 is a flowchart illustrating a music piece transmitting process of the transmitting apparatus 100;

FIG. 17 is a flowchart illustrating the receiving process of the receiving apparatus 200;

FIG. 18 is a flowchart illustrating a reproduction start waiting process of the receiving apparatus 200;

FIG. 19 is a flowchart illustrating an on-reproducing process of the receiving apparatus 200;

FIG. 20 is a flowchart illustrating a delay time correcting process of the transmitting apparatus 100 and the receiving apparatus 200; and

FIG. 21 is a flowchart illustrating a music separating process of the transmitting apparatus 100.

### DETAILED DESCRIPTION OF THE PREFERRED EMBODIMENTS

Preferred embodiments of the present invention will be concretely described below with reference to the drawings, but the present invention is not limited to the embodiments.

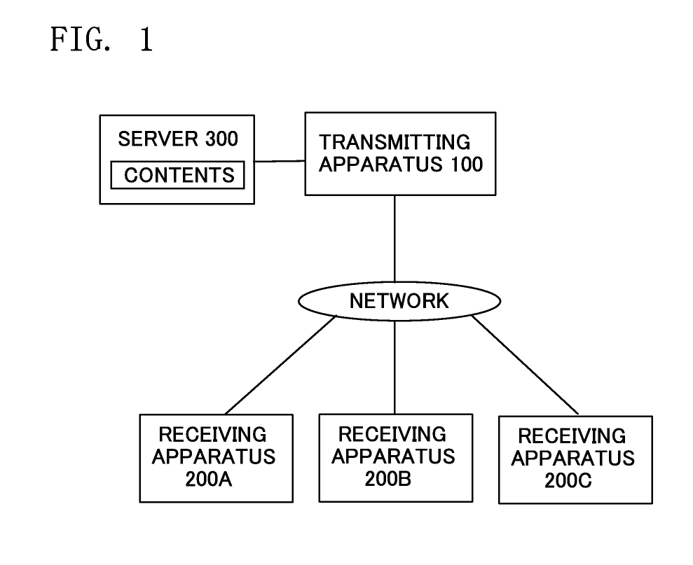

FIG. 1 is a block diagram illustrating a contents reproducing system. The contents reproducing system has a transmitting apparatus 100, a plurality of receiving apparatuses 200 (200A, 200B, 200C or the like) and a server 300. They can be connected to each other via any network such as the Internet or a LAN. The server 300 stores a plurality of contents in a storage medium such as HDD. The contents are general name of music (music piece) data and video (image) data, but in this embodiment, they are music piece data. That is to say, one music piece is one contents.

The transmitting apparatus 100 receives contents data from the server 300, and packetizes the received contents data so as to transmit the contents data of the same contents in the same reproducing positions to the respective receiving apparatuses 200 at the same time. That is to say, the transmitting apparatus 100 multicast-delivers or broadcast-delivers music piece data to the respective receiving apparatuses 200. The server 300 does not have to be connected to the transmitting apparatus 100 via the network, and they may be wireline-connected via an audio cable or the like. Further, the transmitting apparatus 100 may have the function of the server 300.

The respective receiving apparatuses 200 receive the contents data of the same contents in the same reproducing positions at the same time. The respective receiving apparatuses 200 reproduce the received contents data. Each of the receiving apparatuses specifies reception start time at which contents data of next contents is received first, and adds each same delay time set in each of the receiving apparatuses 200 to each of the reception start time so as to set each reproduction start time of the next contents. Therefore, since the respective receiving apparatuses receive the contents data at the same time from the transmitting apparatus 100, the reproduction start times of the contents in the receiving apparatuses are set so as to be equal. Each of the receiving apparatuses 200 determines whether the reproduction start time comes. When the reproduction start time comes, each of the receiving apparatuses 200 ends reproduction of on-reproducing contents, and starts reproduction of the contents data of the next contents in the reproduction start time. As a result, the respective receiving apparatuses can synchronize the reproduction start times for each contents with each other. That is to say, when contents are reproduced, a slight error occasionally occurs on the reproducing positions of the contents being reproduced by the receiving apparatuses 200 due to an error of frequencies of reproducing clocks in the receiving apparatuses. However, when reproduction of next contents is started, the contents reproducing positions can be matched with each other in the respective receiving apparatuses 200.

The transmitting apparatus 100 may also have the function of the receiving apparatuses 200. That is to say, the transmitting apparatus 100 transmits the contents data of the same contents in the same reproducing positions also to the transmitting apparatus 100 as well as the receiving apparatuses 200 at the same time. The transmitting apparatus 100 also specifies a reception start time at which the contents data of next contents is received first similarly to the receiving apparatuses 200, and adds a delay time set in the transmitting apparatus 100 that is the same as those in the receiving apparatuses 200 to the reception start time so as to set a reproduction start time of the next contents. The transmitting apparatus 100 determines whether the reproduction start time comes, and when the reproduction start time comes, ends reproduction of contents currently being reproduced, and starts the reproduction of the contents data of the next contents in the reproduction start time. As a result, the transmitting apparatus also can synchronize the reproduction start time with those in the receiving apparatuses per contents.

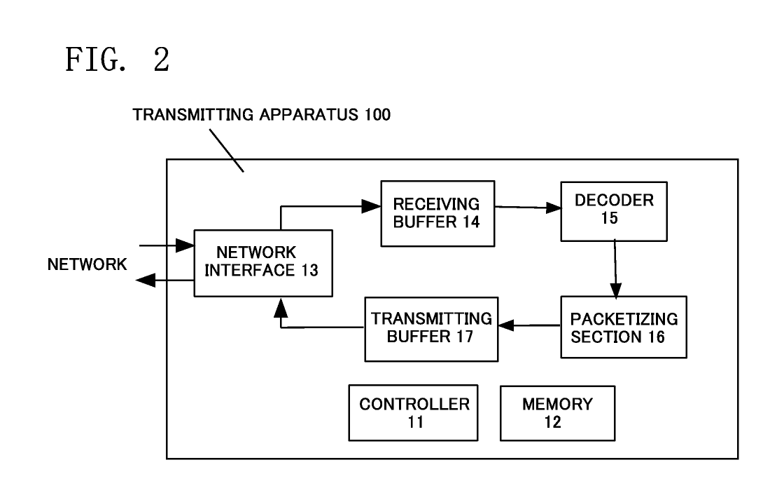

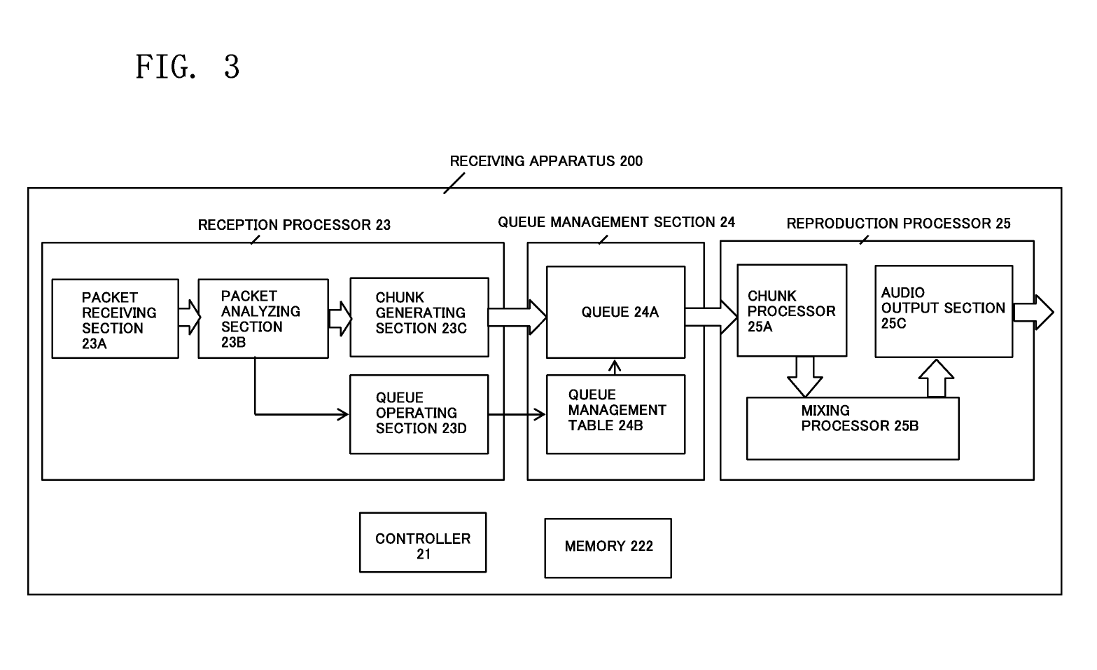

FIG. 2 is a schematic block diagram illustrating a constitution of the transmitting apparatus 100 (in the transmitting apparatus 100, description about the function of the receiving apparatuses 200 is made in FIG. 3). The transmitting apparatus 100 generally has a controller 11, a memory (ROM, RAM or the like) 12, a network interface 13, a receiving buffer 14, a decoder 15, a packetizing section 16, and a transmitting buffer 17.

The controller 11, which is a microcomputer or a CPU, controls the respective sections of the transmitting apparatus 100 based on operation programs of the transmitting apparatus 100 stored in the memory 12. The network interface 13 communicates with the server 300 and the receiving apparatuses 200 via the network, and transmits/receives pieces of data and commands. The receiving buffer 14 temporarily stores music data received from the server 300 via the network interface, and thereafter, supplies the music data to the decoder 15. The decoder 15 decodes the music data so as to convert it into a PCM data row, and supplies it to the packetizing section 16. The packetizing section 16 converts a bunch of PCM data rows into a packet using, for example, any protocol such as an RTP (Real-time Transport Protocol). The packetizing section 16 temporarily stores the packet in the transmitting buffer 17. The controller 11 fetches the packet from the transmitting buffer 17 and adds a header including a time stamp and SSRC to the packet so as to transmit the packet to the respective receiving apparatuses 200 via the network interface 13. The SSRC is identification information representing a music piece defined in the RTP.

FIG. 3 is a block diagram illustrating a constitution of the receiving apparatuses 200 (and the function of the receiving apparatus in the transmitting apparatus 100). Each of the receiving apparatus 200 generally includes a controller 21, a memory 22 (ROM or RAM or the like), a reception processor 23, a queue management section 24, and a reproduction processor 25. The controller 21, which is a microcomputer or CPU, executes an operation program of the receiving apparatus 200 stored in the memory 22 so as to control the respective sections of each of the receiving apparatuses 200.

The reception processor 23 receives a packet of music data transmitted from the transmitting apparatus 100 via the network, and generates a chunk. The chunk is obtained by adding a header to a bunch of PCM data rows. The reception processor 23 has a packet receiving section 23A, a packet analyzing section 23B, a chunk generating section 23C, and a queue operating section 23D. The packet receiving section 23A receives a packet transmitted from the transmitting apparatus 100 via the network, and supplies the packet to the packet analyzing section 23B. The packet analyzing section 23B obtains SSRC included in the header of the packet, and supplies it to the controller 21. When the SSRC included in the received packet is changed, namely, the received music piece is changed into next one, the packet analyzing section 23B specifies a time of the packet reception as a reception start time, and supplies the time to the controller 21. The chunk generating section 23C generates a chunk from the packet, and supplies the chunk to the queue management section 24. The queue operating section 23D updates and controls a queue management table based on an instruction of the controller 21.

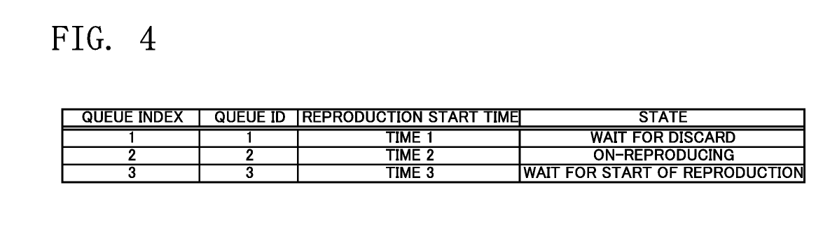

The queue management section 24 generates a queue for each music piece, and stores the chunk in the queue and manages queue information in the queue management table. The queue management section 24 has the queues 24A generated for the respective music pieces, and the queue management table 24B. A new queue is generated when a chunk of a next music piece is supplied from the reception processor 23. The chunk stored in the queue is read by the reproduction processor 25 according to an instruction of the controller 21. FIG. 4 is a diagram illustrating one example of the queue management table. Queue indexes, queue IDs (identification numbers), the reproduction start times and queue states are related with each other, and they are registered in the queue management table. Details of these pieces of information will be described later.

The reproduction processor 25 reproduces the chunk read from the queue management section 24, and outputs an audio signal. The reproduction processor 25 generally has a chunk processor 25A, a mixing processor 25B, and an audio output section 25C. The chunk processor 25A reads a chunk from a queue, and fetches a PCM data row from the chunk. When a cross-fade process is executed in another embodiment, described later, the mixing processor 25B synthesizes PCM data of a previous music piece with PCM data of next music piece. The audio output section 25C temporarily stores a PCM data row from the chunk processor 25A or the mixing processor 25B in a buffer (audio output buffer) of the audio output section 25C, and then outputs an audio.

An operation of the contents reproducing system having the above constitution will be described below.

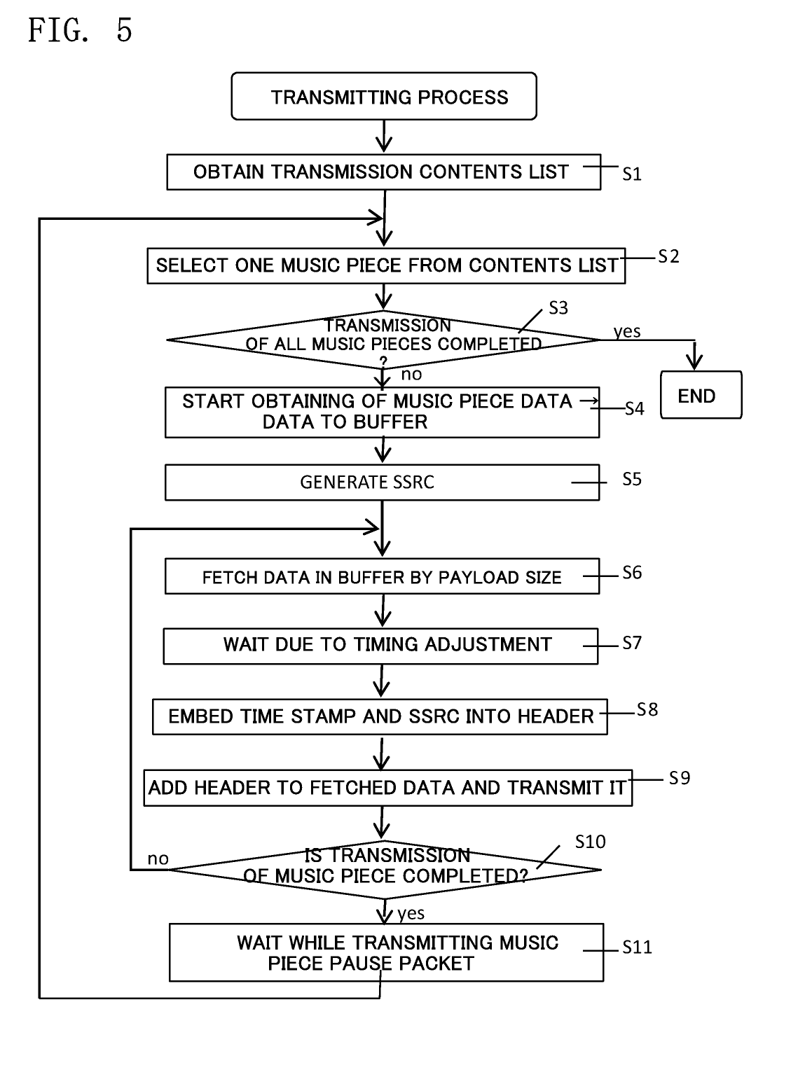

FIG. 5 is a flowchart illustrating a transmitting process of the controller 11 in the transmitting apparatus 100. The controller 11 obtains a contents list from the server 300 via the network, for example, and saves it in the memory 12 (S1). The controller 11 selects one music piece from the contents list (S2). The controller 11 determines whether all the music pieces in the contents list have been completely transmitted to the receiving apparatus 200 (S3). When they have been completely transmitted (YES in S3), the process is ended. When they have not been completely transmitted (NO in S3), the controller 11 obtains all the pieces of data of selected music pieces, for example, from the server 300 via the network, and stores them in the receiving buffer 14 (S4).

The controller 11 generates SSRC of the selected music pieces (S5). The SSRC is identification information for specifying a music piece included in a header of an RTP. The controller 11 reads the music piece data stored in the receiving buffer 14 by a payload length, and decodes to packetize the music piece data so as to store it in the transmitting buffer (S6). The payload length is a maximum size of the music piece data capable of being included in one packet. The controller 11 stands by for a predetermined time due to timing adjustment (S7). The predetermined time is a time necessary for the receiving apparatus 200 to process the music piece data transmitted to the receiving apparatus 200 at the previous time, and more specifically, it is determined according to (a total sum of transmitted samples)/(sampling frequency).

The controller 11 stores a time stamp and the SSRC in the header (S8). The time stamp is mainly information that is used for checking reproduction time information of a missing packet when the receiving apparatus 200 cannot receive the packet. The controller 11 adds the header to the packet of the music piece data and transmits the packet of the music piece data to the receiving apparatuses 200 via the network interface 13 (S9).

The controller 11 determines whether the pieces of data of all the selected music pieces are completely transmitted (S10). When the transmission is not completed (NO in S10), the process returns to S6, and the transmission of the packet of the music piece data is continued. When the transmission is completed (YES in S10), the controller 11 transmits a music piece pause packet and simultaneously stands by for a predetermined time (S11). That is to say, in the receiving apparatuses 200, when a clock frequency of audio reproduction is low, time up to the completion of the reproduction of the music piece data is delayed. Therefore, it is preferable that transmission of next music piece data is waited for a predetermined time so that all the receiving apparatuses 200 end the reproduction of the music piece data and one or more music piece pause is generated until a next music piece is started to be reproduced. While pausing, the controller 11 transmits a music piece pause packet.

In the music piece pause packet, a payload does not include music piece data and a header includes information representing a music piece pause packet. The information representing the music piece pause packet can be realized in such a manner that a music piece pause flag is set to 1. SSRC included in music piece pause packet is SSRC of a music piece whose transmission is ended at the previous time. Thereafter, the process returns to S2, and the controller 11 selects a next music piece from the contents list, so that the above processes are again executed.

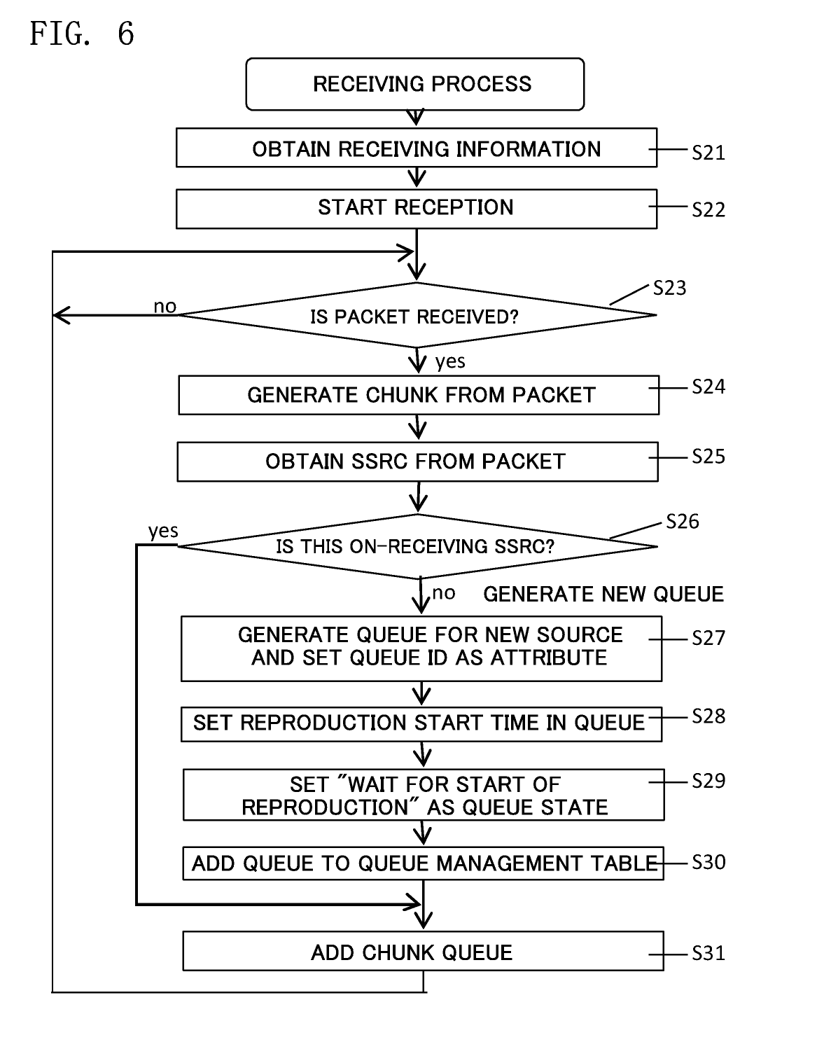

FIG. 6 illustrates a receiving process of the controller 21 of the receiving apparatus 200. The controller 21 obtains information necessary for receiving a music piece data packet (for example, a multicast address or the like) (S21). The controller 21 allows the reception processor 23 to start receiving the packet of the music piece data (S22). When the packet is received (YES in S23), the controller 21 allows the chunk generating section 23C to generate a chunk from the packet (S24). The chunk is such that a header is added to a bunch of PCM data rows to be transmitted to the reproduction processor 25. When the music piece data in the packet is compressed data, decoding is carried out as the need arises.

The controller 21 allows the packet analyzing section 23B to obtain SSRC from the packet (S25). The controller 21 determines whether the obtained SSRC is different from SSRC of the packet received at the last time (S26). That is to say, the controller 21 determines whether the received music piece data is changed into music piece data of a next music piece. When the SSRCs are identical to each other (YES in S26), the controller 21 allows the chunk generating section 23C to store the chunk in a queue related with a music piece being currently reproduced (S31).

On the other hand, when the SSRC is changed (NO in S26), the controller 21 allows the queue management section 24 to generate a queue related to a new music piece, and sets a queue ID of the new queue (S27). The controller 21 sets a reproduction start time to the generated new queue (S28). More specifically, the controller 21 obtains a reception time at which the packet with the changed SSRC (namely, a head packet of a next music piece) from the packet analyzing section 23B, and adds a predetermined delay time to the reception time so as to calculate a reproduction start time of the queue. The same delay time is set in the respective receiving apparatuses 200, and preferably the delay time is set so that all the respective receiving apparatuses 200 can completely reproduce the music piece data.

The controller 21 sets “wait for start of reproduction” as a queue state related to the set new queue ID (S29). The controller 21 registers the queue ID, the reproduction start time and the queue state in the queue management table (S30). The controller 21 allows the reception processor 23 to store the chunk in the set new queue (S31). At this time, the chunk is stored also in the queue of the previous music piece (the music piece being currently reproduced), and queues of two music pieces are generated in an overlapped manner, so that the chunks are stored in the respective queues. Thereafter, the process returns to S23, and the above process is repeated.

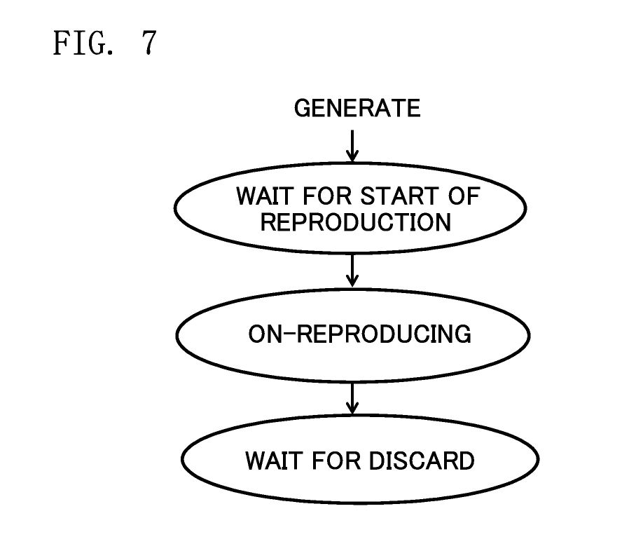

The queue state set in the queue management table will be described below with reference to FIG. 7. “Wait for start of reproduction” is a state from the generation of a new queue to the reproduction start time, and in this state the chunk is stored in the queue, but the reproduction is not started. “On-reproducing” is a state that at the reproduction start time, PCM data is output from the queue to the audio output section 25C. “Wait for discard” is a state that the chunk is not output from the queue to the audio output section because the reproduction start time of the queue of a next music piece comes, namely, a state that the process waits for discard of a queue.

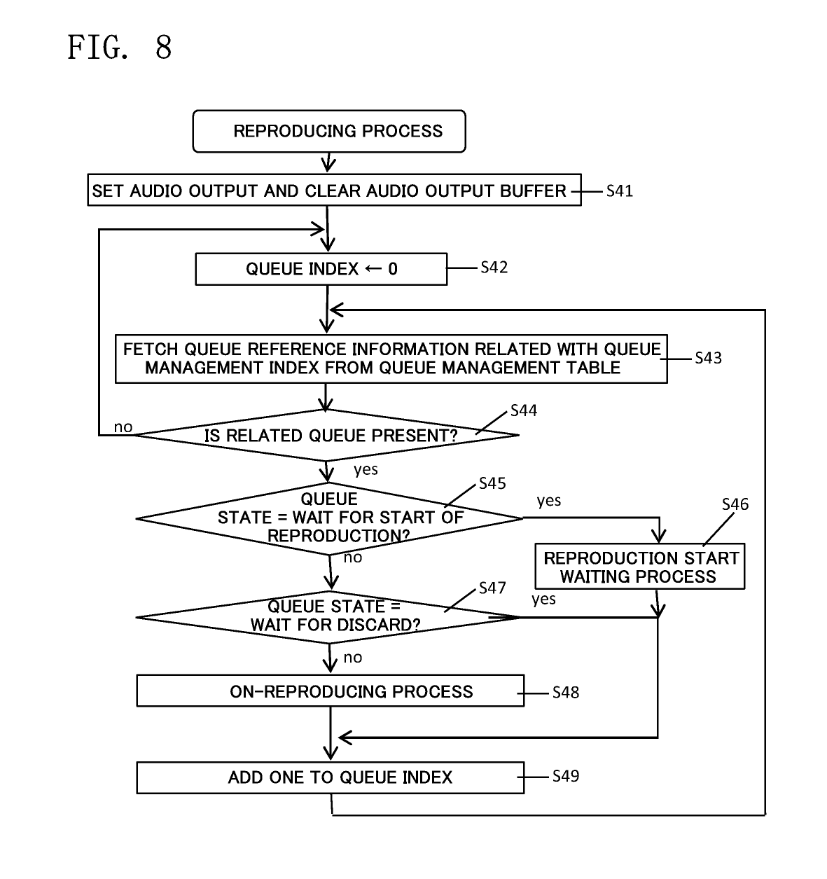

FIG. 8 illustrates a reproducing process of the controller 21 in each of the receiving apparatus 200. The controller 21 sets an audio output in the audio output section 25C (for example, sampling frequency and a quantizing bit number) (S41). The controller 21 clears the audio output buffer of the audio output section 25C (S41). The controller 21 initializes a queue index of the queue management table to 0 (S42).

The controller 21 reads respective pieces of information about queues related to the queue index (the reproduction start time and the queue state) from the queue management table (S43). The controller 21 determines whether the related queues are present (S44). When no queue is present (NO in S44), the process returns to S42. When a queue is present (YES in S44), the controller 21 determines whether the queue state is “wait for start of reproduction” (S45). When “wait for start of reproduction” (YES in S45), a reproduction start waiting process (described later) is executed (S46), and the process goes to S49.

On the other hand, when the state is not “wait for start of reproduction” (NO in S45), the controller 21 determines whether the queue state is “wait for discard” (S47). When the state is “wait for discard” (YES in S47), the process goes to S49. On the other hand, when the state is not “wait for discard” (NO in S47), the controller 21 executes an on-reproducing process (described later) because the queue state is “on-reproducing” (S48), and the process goes to S49. The controller 21 adds 1 to the queue index, and the process returns to S43 so that the above process is repeated. That is to say, the above processes is executed on the queues registered in the queue management table in order of the queue index.

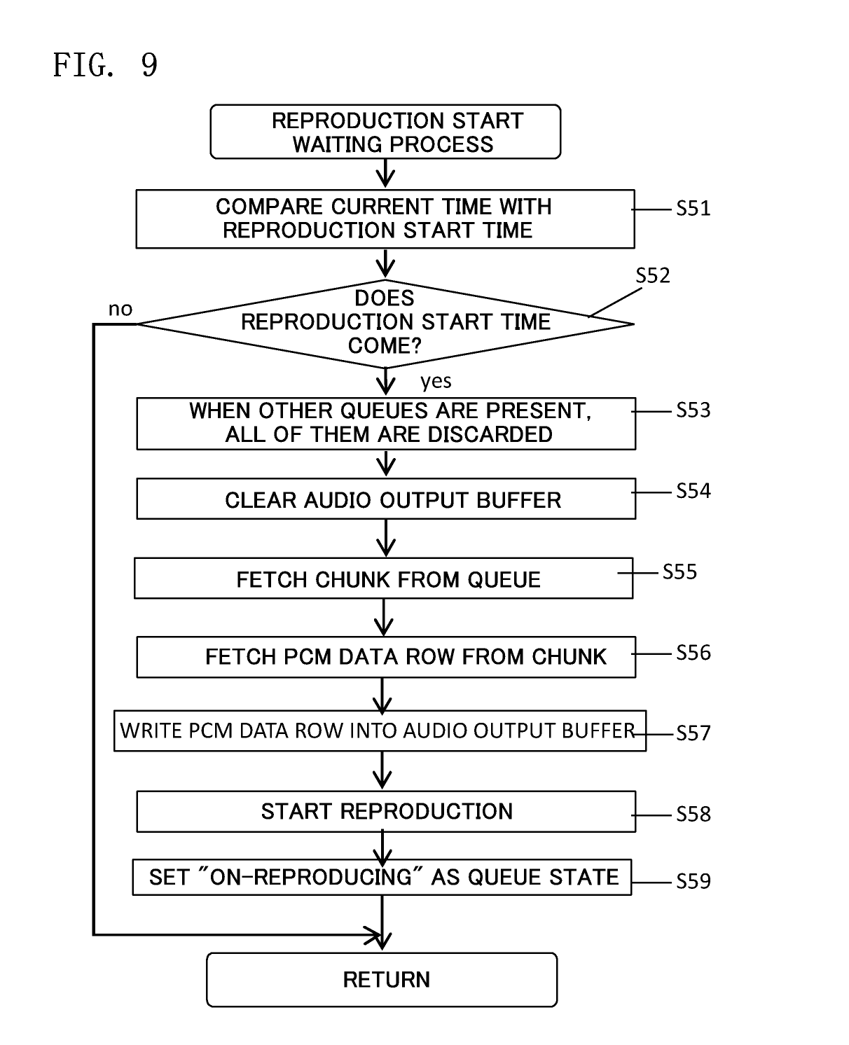

FIG. 9 illustrates details of the reproduction start waiting process (S46). The controller 21 compares a current time with the reproduction start time of a queue (S51). The current time is a time managed by the respective receiving apparatus 200 themselves. When the reproduction start time does not yet come (NO in S52), the process is ended. When the reproduction start time comes (YES in S52) and other queues are present, the controller 21 allows the queue management section 24 to discard all the other queues, and deletes pieces of information about the discarded queues from the queue management table (S53). That is to say, queues which store or stored the chunk of the previous music piece are discarded.

The controller 21 allows the audio output section 25C to clear the audio output buffer (S54). To clear means to delete all pieces of data in the buffer. As a result, even when the previous music data remains in the buffer, all pieces of music piece data in the buffer are deleted. Therefore, when the reproduction start time for a music piece comes, the reproduction of music piece data can be started immediately. For this reason, the reproduction start times are set to the same time, the reproduction start times for a music piece can be synchronized with each other in the transmitting apparatus 100 and the respective receiving apparatuses 200.

The controller 21 allows the queue management section 24 to read the chunk from the queue, and to supply it to the chunk processor 25A (S55). The chunk processor 25A fetches a PCM data row from the chunk according to the instruction from the controller 21 (S56), and stores it in the audio output buffer of the audio output section 25C (S57). The controller 21 allows the audio output section 25C to start the reproduction of PCM data stored in the audio output buffer (S58). The controller 21 changes the queue state in the queue management table into “on-reproducing” (S59).

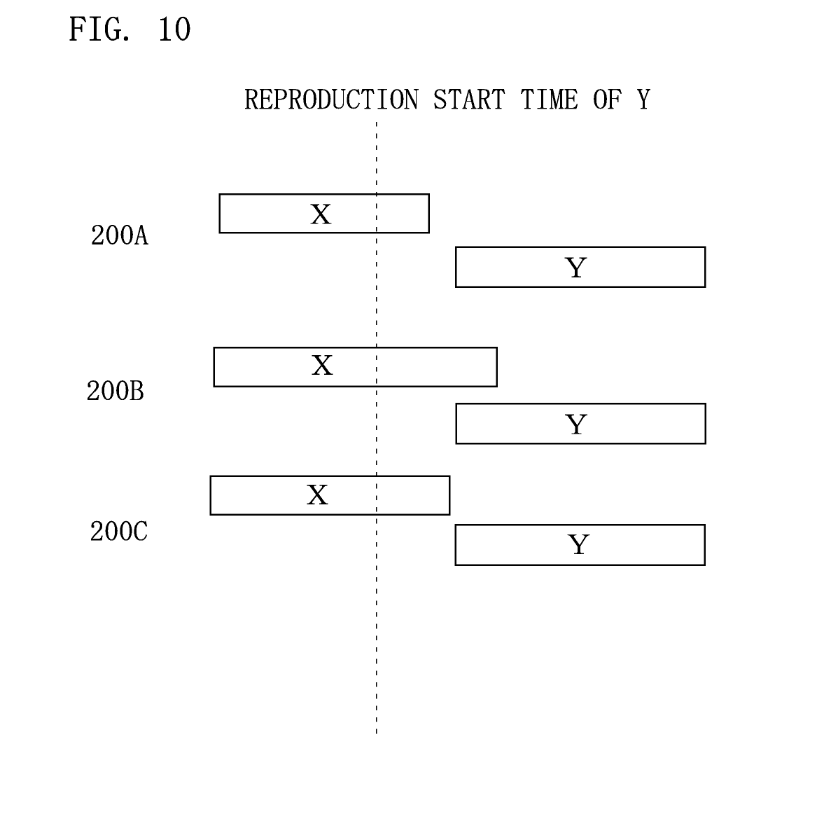

FIG. 10 is a diagram schematically illustrating reproduction timings of a previous music piece and a next music piece in the respective receiving apparatuses 200, and in the diagram an abscissa axis represents time. The respective receiving apparatuses 200A to 200C start to reproduce a music piece Y at the same reproduction start time, and the reproduction start times are synchronized with each other. The respective receiving apparatuses 200A and 200C end the reproduction of a previous music piece X before the reproduction start time for the music piece Y. On the other hand, since the receiving apparatus 200B cannot completely reproduce the previous music piece X until the reproduction start time for the music piece Y, the reproduction of the next music piece Y is started without reproducing an end portion of the music piece X. At least in all the receiving apparatuses 200, the reproduction start times for music pieces can be synchronized with each other.

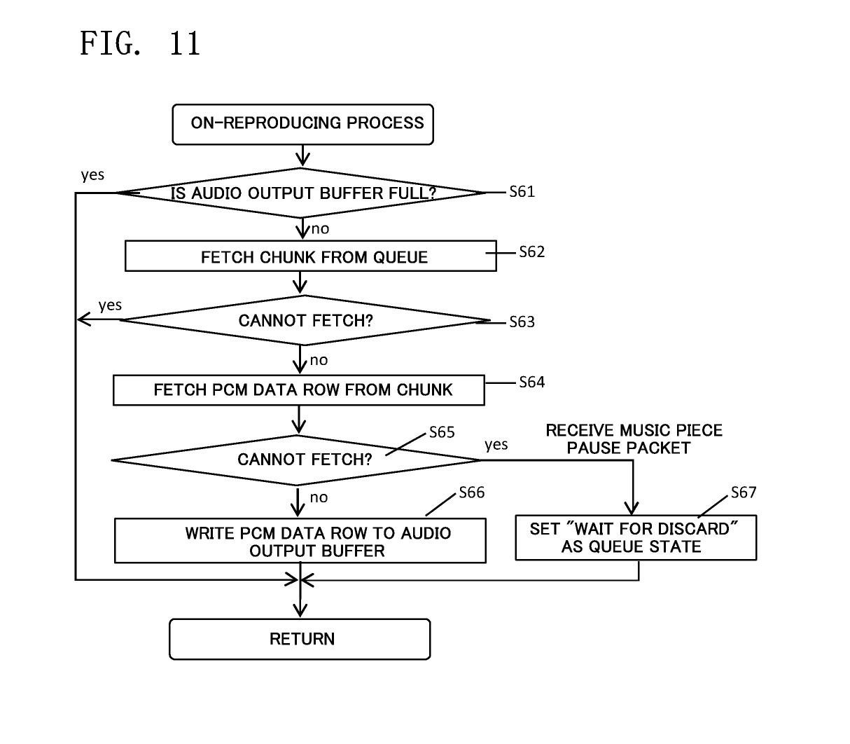

FIG. 11 illustrates details of a process of “on-reproducing” (S48). The controller 21 determines whether the audio output buffer of the audio output section 25C is filled with data (S61). When the buffer is filled with data (YES in S61), the process is ended. When the buffer is not filled with data (NO in S61), the controller 21 allows the queue management section 24 to further read the chunk from the queue, and to supply it to the chunk processor 25A (S62). The controller 21 determines whether the chunk cannot be fetched from the queue (S63), and when the chunk cannot be fetched (YES in S63), the process is ended. When the chunk can be fetched (NO in S63), the controller 21 allows the chunk processor 25A to fetch the PCM data row from the chunk (S64).

The controller 21 determines whether the PCM data row cannot be fetched (S65). When it cannot be fetched (YES in S65), data is the music piece pause packet, and thus the queue state in the queue management table is changed into “wait for discard” (S67). When the PCM data row can be fetched (NO in S65), the controller 21 stores the PCM data row in the audio output buffer of the audio output section 25C (S66).

According to the embodiment, as described above, each of the receiving apparatuses 200 receives a head packet of a music piece at the same time, and adds a predetermined delay time to the reception time so as to set the reproduction start time for the music piece. Since the reproduction of the music piece is started at the reproduction start time whether the previous music piece is being reproduced or not, the reproduction start times can be synchronized with each other for each music piece.

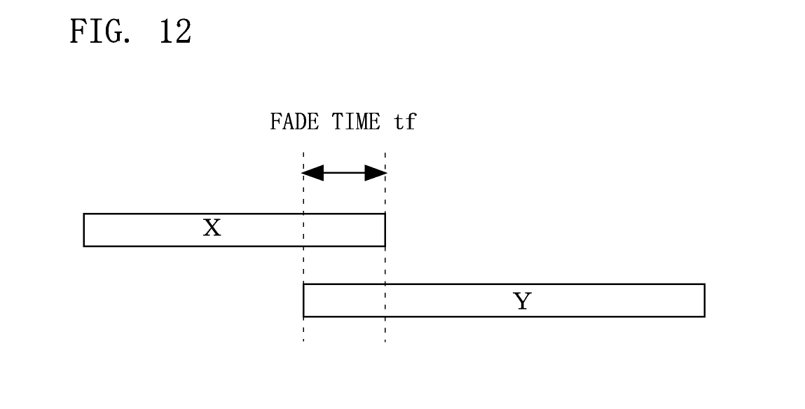

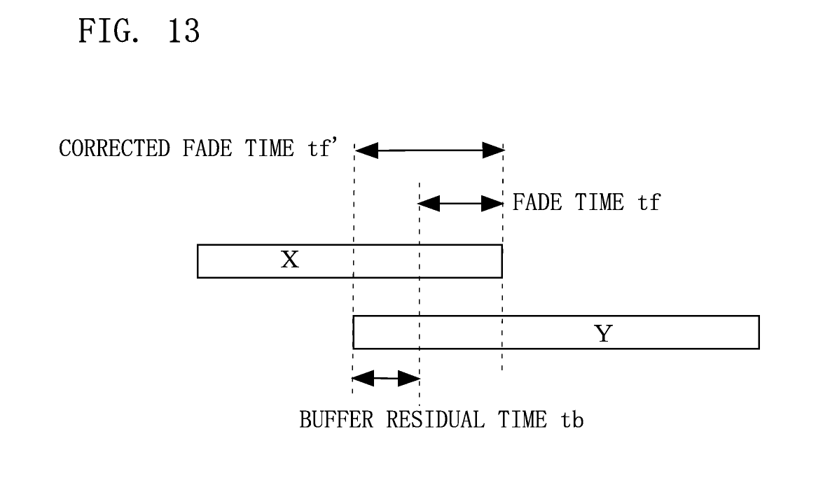

Another preferred embodiment of the present invention will be described below. In this embodiment, each of the receiving apparatuses 200 executes a cross-fade process. That is to say, as shown in FIG. 12, the reproduction of music piece data is faded out around the end of the previous music piece X and the next music piece Y is faded in so that its head portion is overlapped with a fade-out segment of the previous music piece X. In such a manner, the music pieces X and Y are synthesized and an audio is output. A time required for the synthesizing and the output is a fade time tf, and it is, for example, 3 seconds. In this embodiment, when the cross-fade is performed, the reproduction for each music piece should be synchronized with each other in the respective receiving apparatuses. For this reason, as shown in FIG. 13, when the head packet of the next music piece Y is received, the reproduction start times for the next music piece Y is corrected to be earlier by residual reproduction time tb for data remaining in the audio output buffer. As a result, the start time of the cross-fade is also corrected to be earlier by the residual reproduction time tb for the data remaining in the audio output buffer. The process is executed because when the cross-fade process is executed, the reproduction start times cannot be synchronized with each other by clearing the audio output buffer like the former embodiment.

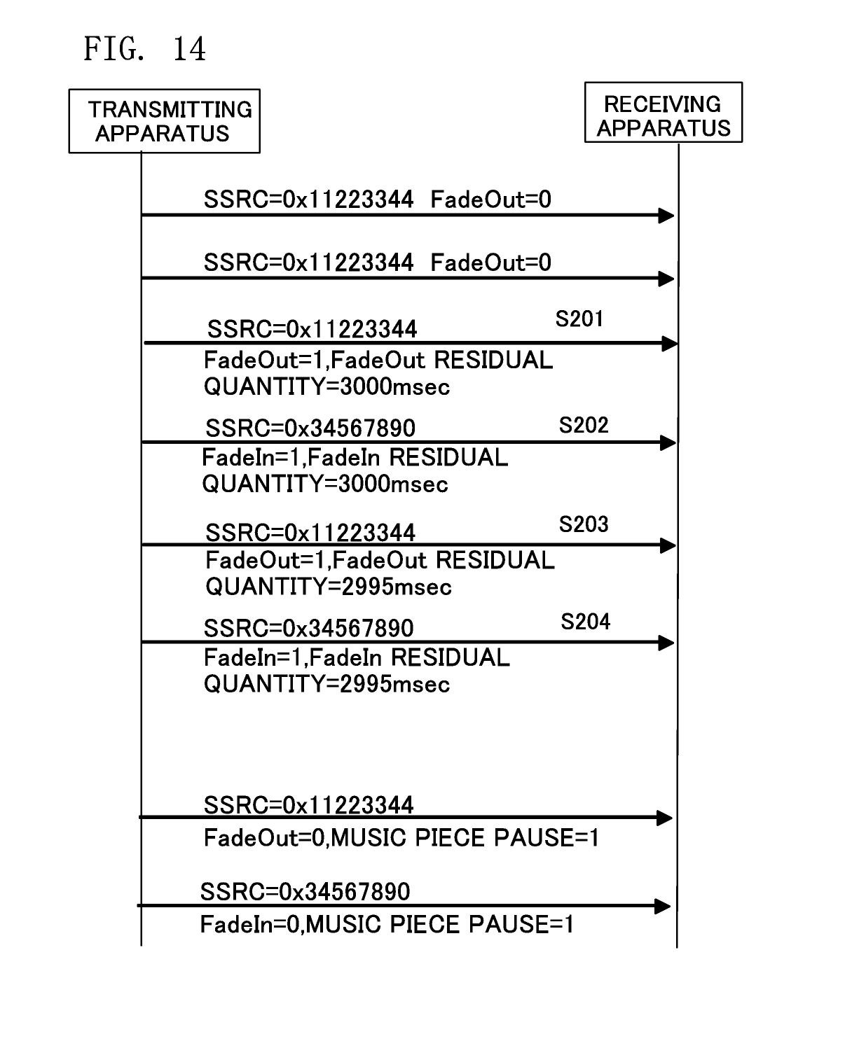

As shown in FIG. 14, a header of a packet to be transmitted from the transmitting apparatus 100 to the receiving apparatuses 200 includes a fade-in flag, a fade-out flag, a fade-in residual quantity and a fade-out residual quantity. The fade-out flag indicating 1 means to fade out, and the fade-in flag indicating 1 means to fade in. A packet to be transmitted in S201 is a packet of a previous music piece (SSRC=0x11223344) and represents that fade-out is carried out and the fade-out residual quantity is 3000 msec. A packet to be transmitted in S202 is a packet of a next music piece (SSRC=0x3457890), and represents that fade-in is carried out and the fade-in residual quantity is 3000 msec. A packet to be transmitted in S203 is a packet of the previous music piece (SSRC=0x11223344), and represents that fade-out is carried out and the fade-out residual quantity is 2995 msec. A packet to be transmitted in S204 is a packet of the next music piece (SSRC=0x34567890), and represents that fade-in is carried out and the fade-in residual quantity is 2995 msec. In such a manner, the packet of a previous music piece to be faded out and the packet of a next music piece to be faded in are transmitted in a mixed manner for a period of the cross-fade process.

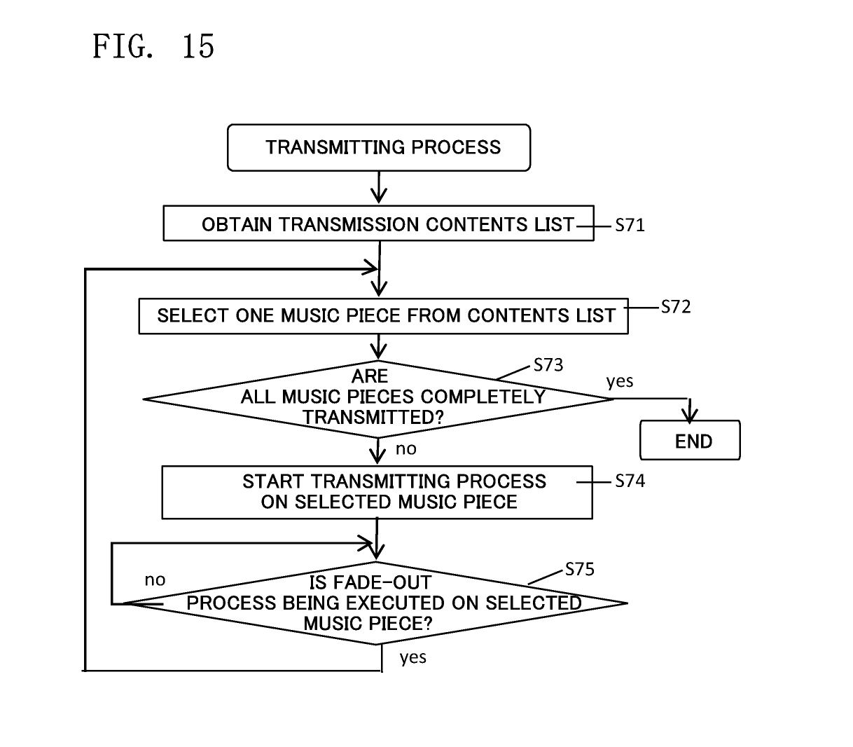

FIG. 15 is a flowchart illustrating the transmitting process of the controller 11 of the transmitting apparatus 100. The controller 11 obtains the contents list from the server 300 via the network, for example, and saves it in the memory 12 (S71). The controller 11 selects one music piece from the contents list (S72). The controller 11 determines whether all the music pieces in the contents list are completely transmitted to the receiving apparatuses 200 (S73). When all the music pieces are completely transmitted, (YES in S73), the process is ended. When they are not completely transmitted (NO in S73), the controller 11 starts a transmitting process for the selected music piece (S74). The controller 11 determines whether the selected music piece is being faded out (S75). When being faded out (YES in S75), the process returns to S72 and goes to the transmitting process for a next music piece.

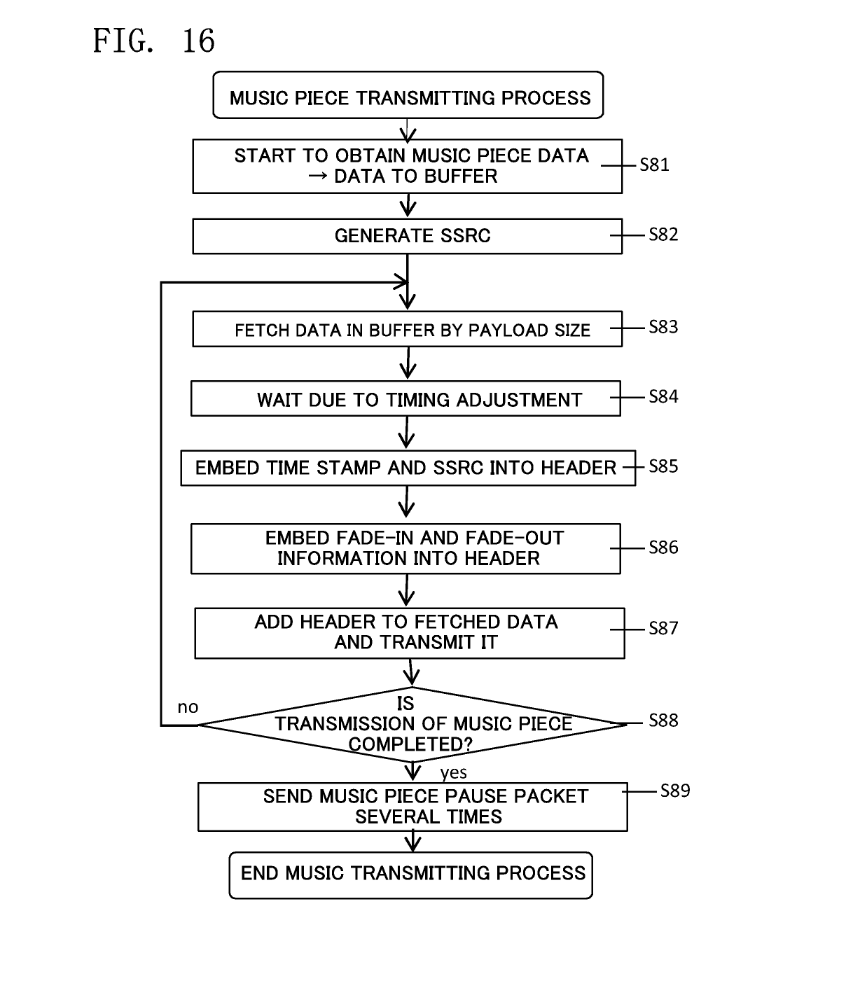

FIG. 16 illustrates details of the transmitting process for music pieces (S74). The controller 11 obtains all pieces of data of the selected music pieces, for example, from the server 300 via the network, and stores the pieces of data in the receiving buffer 14 (S81). The controller 11 generates SSRC of the selected music pieces (S82). The controller 11 reads music piece data stored in the receiving buffer 14 by a payload length, and decodes and packetizes the music piece data so as to store it in the transmitting buffer (S83). The controller 11 stands by for a predetermined time due to timing adjustment (S84). The controller 11 stores a time stamp and the SSRC in the header (S85).

The controller 11 stores information about fade-in or fade-out in the header. More specifically, when the cross-fade is carried out for 3 seconds, the controller 11 determines whether data up to 3 seconds before the end of the music piece is transmitted. At the time of the data up to 3 seconds before the end of the music piece, the controller 11 sets the fade-out flag to 1, and sets the fade-out residual quantity. Similarly, the controller 11 determines whether the data is data up to 3 seconds after the head of the music piece, and when the data is one up to 3 seconds after the head of the music piece, the controller sets the fade-in flag to 1, and sets the fade-in residual quantity. A packet of a music piece to be faded out and a packet of a music piece to be faded in are transmitted alternately, as described above. The controller 11 adds a header to the packet of the music piece data, and transmits the packet of the music piece data to the respective receiving apparatuses 200 via the network interface 13 (S87).

The controller 11 determines whether entire data of selected music pieces is completely transmitted (S88). When the transmission is not completed (NO in S88), the process returns to S83, and the transmission of the packet of the music piece data is continued. When the transmission is completed (YES in S88), the controller 11 transmits a music piece pause packet and simultaneously stands by for a predetermined time (S89).

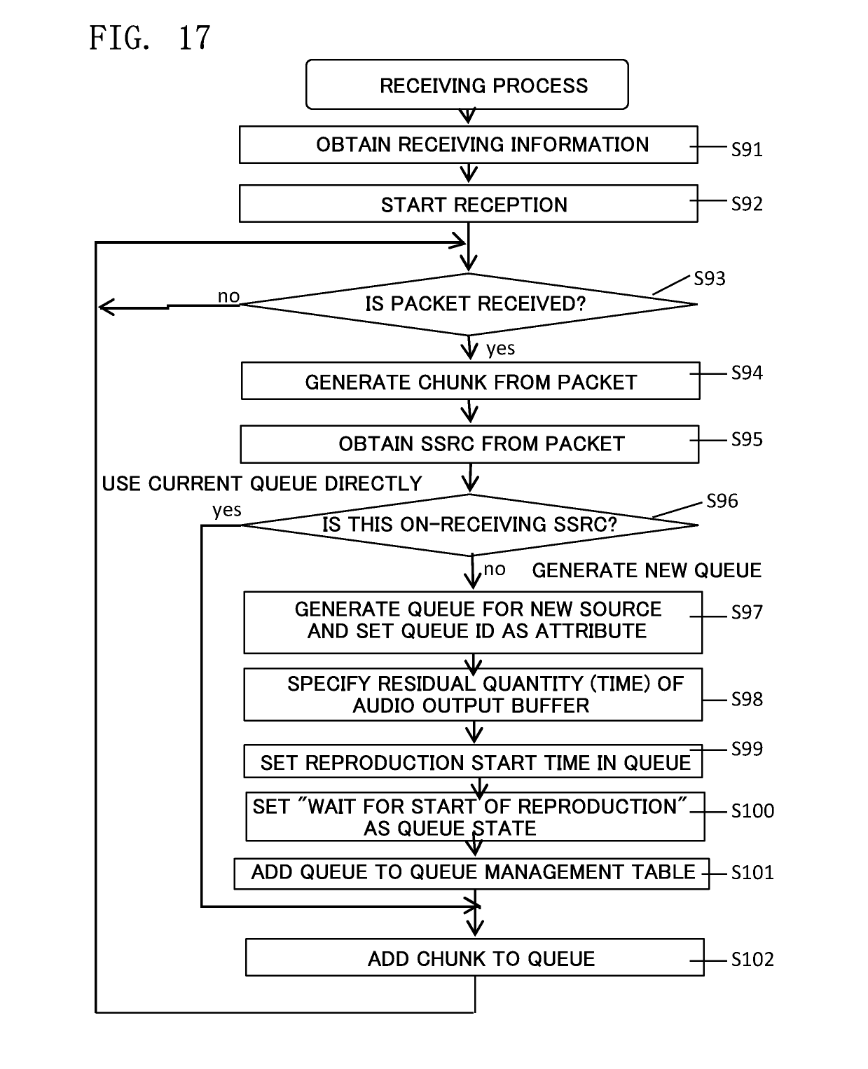

FIG. 17 illustrates the receiving process of the controller 21 of each of the receiving apparatuses 200. The controller 21 obtains information necessary for receiving the packet of the music piece data (S91). The controller 21 allows the reception processor 23 to start receiving the packet of the music piece data (S92). When the packet is received (YES in S93), the controller 21 allows the chunk generating section 23C to generate the chunk from the packet (S94).

The controller 21 allows the packet analyzing section 23B to obtain SSRC from the packet (S95). The controller 21 determines whether the obtained SSRC is different from SSRC of the previously received packet (S96). When both the SSRC are the same as each other (YES in S96), the controller 21 allows the chunk generating section 23C to store the chunk in a queue related with an on-reproducing music piece (S102).

On the other hand, when the SSRC is changed (NO in S96), the controller 21 allows the queue management section 24 to generate a queue related to a new music piece, and sets a queue ID of the new queue (S97). The controller 21 specifies data residual time of an on-reproducing music piece remaining in the audio output buffer of the audio output section 25C (S98). The data residual time is a time required for completely reproducing data remaining in the audio output buffer. The controller 21 adds a predetermined delay time to the reception start time for a music piece and subtracts the data residual time of the audio output buffer so as to calculate the reproduction start time of a next music piece (S99).

The controller 21 sets “wait for start of reproduction” as the queue state (S100). The controller 21 registers the queue ID, the reproduction start time and the queue state in the queue management table (S101). The controller 21 allows the reception processor 23 to store the chunk in a generated new queue (S102).

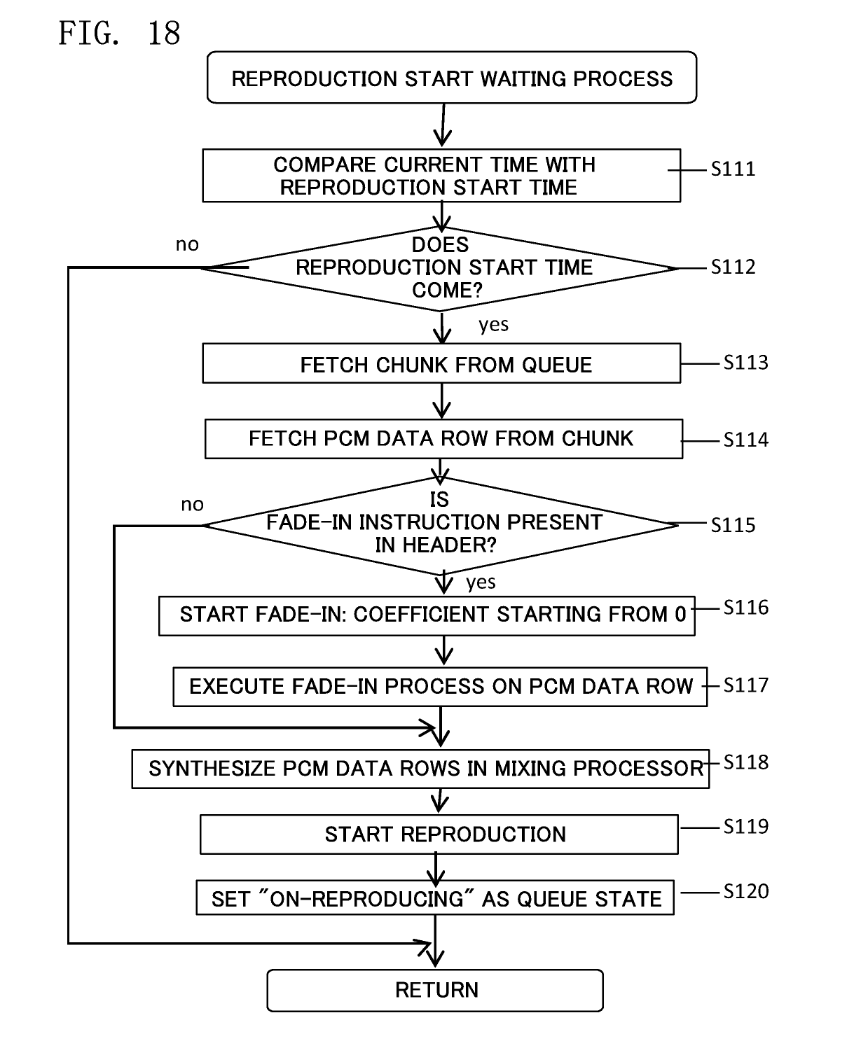

FIG. 18 illustrates the reproduction start waiting process. The controller 21 compares the current time with the reproduction start time of the queue (S111). When the reproduction start time does not yet come (NO in S112), the process is ended. When the reproduction start time comes (YES in S112), the controller 21 allows the queue management section 24 to read the chunk from the queue and supply it to the chunk processor 25A (S113). The chunk processor 25A fetches the PCM data row from the chunk according to an instruction from the controller 21 (S114). The controller 21 determines whether the header includes a fade-in instruction (S115). When the header does not include the fade-in instruction (NO in S115), the process goes to S118. When the header includes a fade-in instruction (YES in S115), the controller 21 allows the reproduction processor 25 to start the fade-in process. The fade-in gradually increases a volume level approximately linearly from 0 towards the end of the fade-in. Therefore, the volume level is adjusted within a corrected fade time tf′ shown in FIG. 13 so as to increases from 0 to a user set value. The controller 21 allows the reproduction processor 25 to execute the fade-in process on the PCM data row (S117).

Thereafter, the controller 21 allows the mixing processor 25B to synthesize the PCM data row of the previous music piece with the PCM data row of the music piece in the reproduction start time (S118) and start the reproduction (S119). The controller 21 changes the queue state in the queue management table into “on-reproducing” (S120).

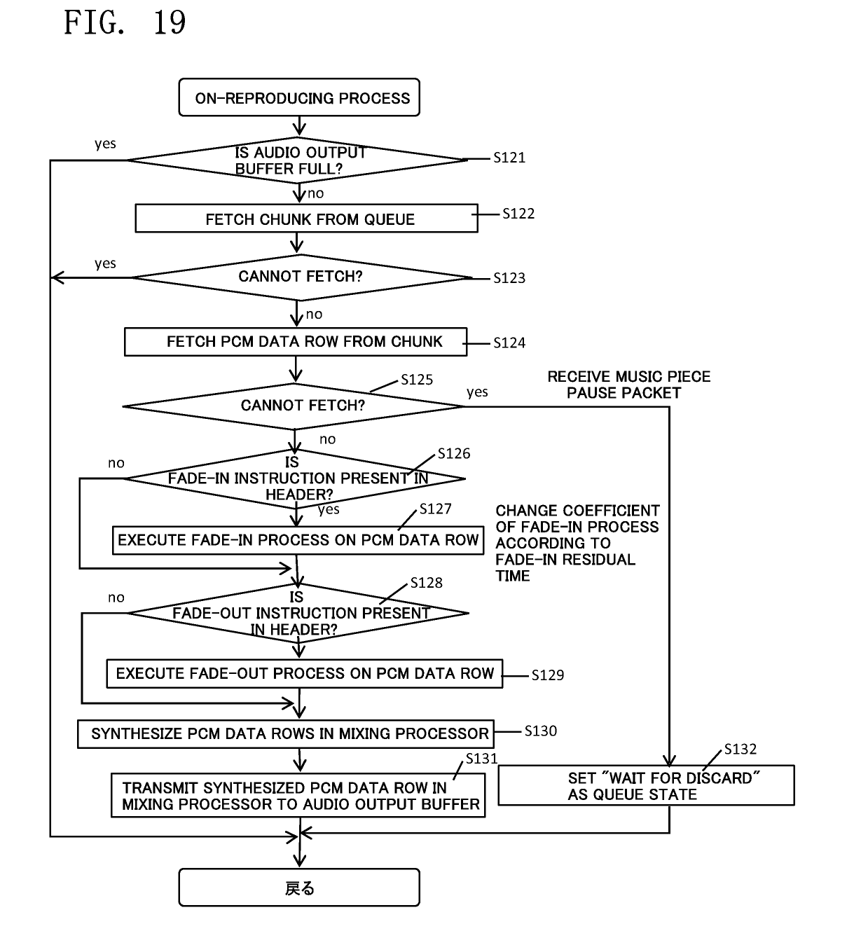

FIG. 19 illustrates the process of “on-reproducing”. The controller 21 determines whether the audio output buffer of the audio output section 25C is filled with data (S121). When the buffer is filled with data (YES in S121), the controller 21 waits until writing is enabled, and thus ends the process. When the buffer is not filled with data (NO in S121), the controller 21 allows the queue management section 24 to read the chunk from the queue and supply it to the chunk processor 25A (S122). When the chunk cannot be fetched (YES in S123), the process is ended. When the chunk can be fetched (NO in S123), the controller 21 allows the chunk processor 25A to fetch the PCM data row from the chunk (S124). When the PCM data row cannot be fetched (YES in S125), it means a music piece pause packet, and thus the queue state in the queue management table is changed into “wait for discard” (S132).

When the PCM data row can be fetched (NO in S125), the controller 21 determines whether the header includes the fade-in instruction (S126). When the header does not include the fade-in instruction (NO in S126), the process goes to S128. When the header includes the fade-in instruction (YES in S126), the controller 21 executes the fade-in process on the PCM data row (S127). These steps are the same as S116 and S117, and the volume level is determined according to the fade-in residual quantity. The controller 21 determines whether the header includes the fade-out instruction (S128). When the header does not include the fade-out instruction (NO in S128), the process goes to S130. When the header includes the fade-out instruction (YES in S128), the controller 21 executes the fade-out process on the PCM data row (S129). The fade-out gradually reduces the volume level from a user set value to 0 approximately linearly from a fade-out start time to the end of the music piece. Therefore, the volume level is adjusted within the corrected fade time tf′ shown in FIG. 13 so as to reduce from the user set value to 0. That is to say, the volume level is determined according to the fade-out residual quantity. The controller 21 allows the mixing processor 25B to synthesize the PCM data row of the previous music piece with the PCM data row of the next music piece (S130) and transmit the synthesized PCM data row to the audio output buffer (S131).

The above process enables the reproduction times of the receiving apparatuses to be synchronized with each other even when the cross-fade is carried out.

Still another embodiment of the present invention will be described. In this embodiment, when each of the receiving apparatuses 200 clears the audio output buffer at the reproduction start time of a music piece, the apparatus 200 specifies a residual quantity (residual time) of the audio output buffer and notifies the transmitting apparatus 100 of the residual quantity. The transmitting apparatus 100 specifies a maximum residual time in the residual quantities (the residual times) of the audio output buffers received from the receiving apparatuses 200 respectively, and adds the specified residual time to the delay times so as to set new delay times and transmit them to the receiving apparatuses 200, respectively. The receiving apparatuses 200 set the reproduction start times in the embodiment using the received new delay times. As a result, the delay times can be corrected so that all the receiving apparatuses 200 completely reproduce the ends of a music piece and then can start the reproduction of a next music piece.

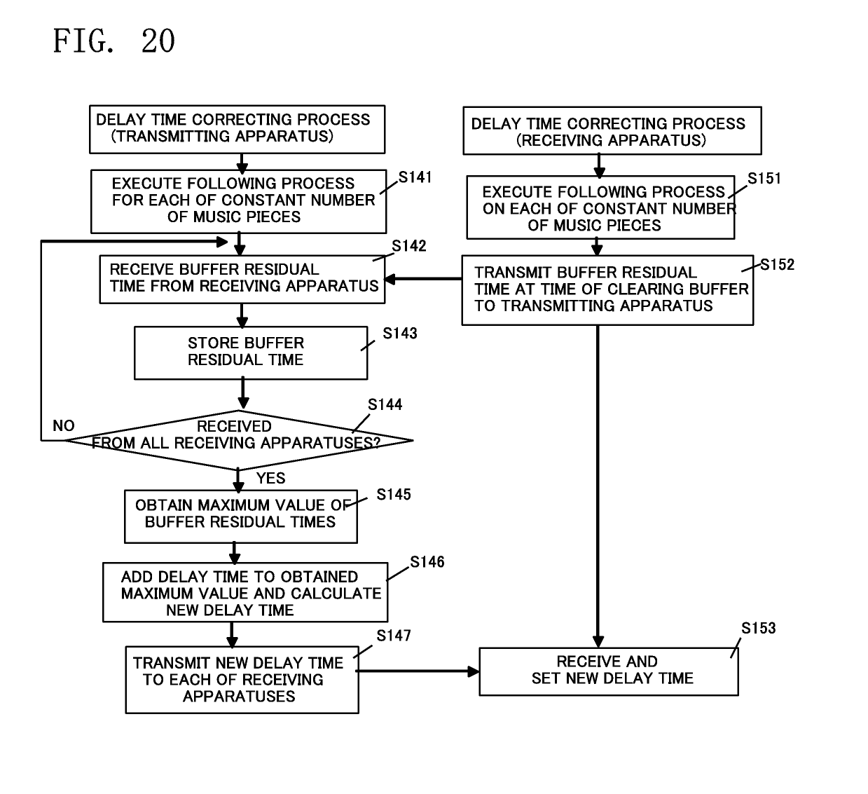

FIG. 20 is a flowchart illustrating a process in this embodiment. This process may be periodically executed, for example, on each of a predetermined number of music pieces similarly to S141 and S151. The controller 21 of each of the receiving apparatuses 200 specifies the residual time of the audio output buffer at the time of clearing the audio output buffer, and transmits the residual time to the transmitting apparatus 100 (S152). The residual time of the audio output buffer is a time required for reproducing data remaining in the audio output buffer (namely, to be cleared). The controller 11 of the transmitting apparatus 100 receives the residual times of the audio output buffers from the receiving apparatuses 200 (S142), and stores them in the memories 22 (S143). The controller 11 of the transmitting apparatus 100 determines whether the residual times of the audio output buffers are received from all the receiving apparatuses 200 (S144), and when not yet received (NO in S144), the process returns to S142. When received (YES in S144), the controller 11 obtains a maximum value of the residual time of the audio output buffer in the residual times of the audio output buffers received from the respective receiving apparatuses 200 (S145). The controller 11 adds the obtained maximum value of the residual times of the audio output buffers to the present delay times so as to set new delay times (S146). The controller 11 transmits the set new delay times to the receiving apparatuses 200, respectively (S147). The controllers 21 of the receiving apparatuses 200 receive the new delay times, respectively, and store them in the memories 22 (S153), and thereafter set the reproduction start times using the new delay times.

Still another embodiment of the present invention will be described. When contents that are received and transmitted to the receiving apparatuses 200 by the transmitting apparatus 100 are an audio signal such as radio broadcasting and analog audio signal where a plurality of music pieces continue, the reproduction starting positions for each music piece cannot be synchronized with each other unlike the above embodiment, and a shift of the reproducing positions become more noticeable among the receiving apparatuses 200 over the reproduction time. In order to solve this, even in a case of audio signal continuously input, a silent segment is detected, a music piece pause is formed in the silent segment, and SSRC is changed so that the data after the silent segment is transmitted as another music piece.

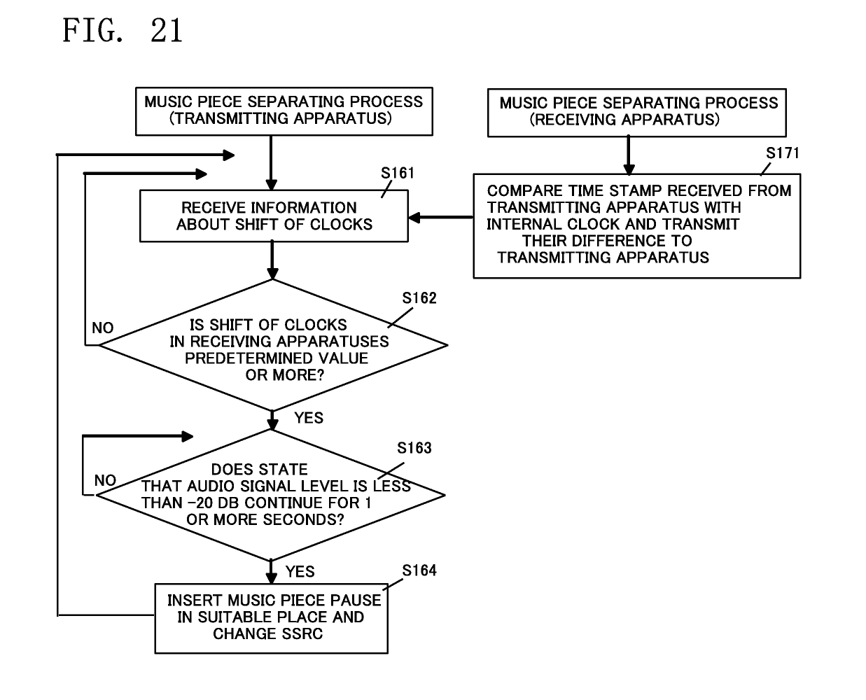

As shown in FIG. 21, the controller 21 of each of the receiving apparatuses 200 compares a reference clock received from the transmitting apparatus 100 (this is a time stamp included in a header of a packet) with a clock managed by each of the receiving apparatuses 200 itself (this is such that a clock generated by the receiving apparatus 200 is added to a time stamp included in a packet received first in on receiving SSRC and this is counted) so as to transmit a difference (shift) to the transmitting apparatus 100 (S171). The shift of the clocks may be transmitted every predetermined time (for example, ten seconds).

The controller 11 of the transmitting apparatus 100 receives the information about the clock shift from the receiving apparatuses 200 (S161). The controller 11 determines whether the received clock shift is a predetermined value or more (S162). When the clock shift is less than the predetermined value (NO in S162), the shift is within an acceptable range, and thus the process returns to S161 without forming a music piece pause. When the clock shift is the predetermined value or more (YES in S162), it exceeds the acceptable range, and thus the process for forming a music piece pause is executed. The controller 11 determines whether a state that an audio signal level (amplitude) is less than a value regarded as silent (for example, −20 dB) continues for a predetermined time (for example, 1 second), and stands by (S163). When the state of less than −20 dB continues for one second (YES in S163), the controller 11 forms a music piece pause in this place, and changes SSRC so as to transmit its packet and the following packets as another music piece (contents) to the respective receiving apparatuses 200 (S164). Therefore, even when the contents are an audio signal such as a radio broadcasting or analog audio signals where a plurality of music pieces continue, the audio signal is transmitted virtually as another music piece in a segment determined as silent to the respective receiving apparatuses 200, so that the reproduction start times of another music piece can be synchronized with each other among the receiving apparatuses 200.

The above described the preferred embodiments of the present invention, but the present invention is not limited to these embodiments. Computer programs for allowing the transmitting apparatus 100 and the receiving apparatuses 200 of the present invention to operate or a recording medium in which the computer programs are recorded may be provided.

What is claimed is:

1. A contents reproducing system for sequentially reproducing a plurality of contents, comprising:
a transmitting apparatus; and
a plurality of receiving apparatuses connectable with the transmitting apparatus via a network, wherein
the transmitting apparatus has a transmitting section for transmitting contents data of same contents on a same reproducing position to the respective receiving apparatuses at a same time,
each of the receiving apparatuses includes
a receiving section for receiving the contents data from the transmitting apparatus,
a reproducing section for reproducing the received contents data,
a time specifying section for specifying a reception start time at which contents data of next contents is received first,
a start time setting section for adding a delay time set to the same time in each of the receiving apparatuses to the reception start time, and setting a reproduction start time of next contents,
a time determining section for determining whether the reproduction start time comes, and
a reproduction controller for, when the determination is made that the reproduction start time comes, allowing the reproducing section to end the reproduction of the on-reproducing contents and start the reproduction of the contents data of the next contents in the reproduction start time.

2. The contents reproducing system according to claim 1, wherein
when the determination is made that the reproduction start time comes, the reproduction controller allows the reproducing section to delete all the contents data of the on-reproducing contents from a storage region and store the contents data of the next contents in the reproduction start time so as to start the reproduction of the contents data of the next contents in the reproduction start time.

3. The contents reproducing system according to claim 1, wherein
the transmitting section transmits information representing fade-out or information representing fade-in together with the contents,
the reproducing section carries out synthesizing and reproduction so that an end portion of the previous contents is faded out and a head portion of the next content is faded in,
the start time setting section adds the delay time to the reception start time, and subtracts a residual reproduction time accumulated in the buffer at the time of first receiving the contents data of the next contents so as to set the reproduction start time.

4. The contents reproducing system according to claim 1, wherein
each of the respective receiving apparatuses further has a residual reproduction time transmitting section for transmitting a residual reproduction time of the on-reproducing contents at a time when the determination is made that the reproduction start time comes to the transmitting apparatus,
the transmitting apparatus further has
a residual reproduction time receiving section for receiving the residual reproduction times of the on-reproducing contents at a time when the determination is made that the reproduction start time comes from the respective receiving apparatuses,
a delay time calculator for specifying maximum value of the residual reproduction times received from the respective receiving apparatuses and adds the maximum value to the delay time so as to calculate new delay time, and
a delay time transmitting section for transmitting the calculated new delay time to the receiving apparatuses, respectively,
each of the receiving apparatuses further has a delay time receiving section for receiving the calculated new delay time,
the start time setting section adds the calculated new delay time to the reception start time, and sets a reproduction start time of next contents.

5. The contents reproducing system according to claim 1, wherein
the plurality of contents is a continuous audio signal,
each of the receiving apparatuses further has a difference information transmitting section for transmitting information about a difference between a reference clock received from the transmitting apparatus and a clock managed in each of the receiving apparatuses to the transmitting apparatus,
the transmitting apparatus further has
a difference information receiving section for receiving the difference information from each of the receiving apparatuses, and
a contents separating section for, when the received difference information is a predetermined value or more and an audio signal level is less than a predetermined level at which the audio signal is determined as silent, separating the contents as another contents on a portion where the audio signal level is less than the predetermined level.

6. A contents reproducing system for sequentially reproducing a plurality of contents, comprising:
a transmitting apparatus; and
a receiving apparatus connectable with the transmitting apparatus via a network, wherein
the transmitting apparatus has a transmitting section for transmitting contents data of same contents on a same reproducing position to the receiving apparatus and the transmitting apparatus at a same time,
the receiving apparatus and the transmitting apparatus have
a receiving section for receiving the contents data from the transmitting apparatus,
a reproducing section for reproducing the received contents data,
a time specifying section for specifying a reception start time at which contents data of next contents is received first,
a start time setting section for adding a delay time set to the same time in each of the receiving apparatus and the transmitting apparatus to the reception start time so as to set a new reproduction start time of contents,
a time determining section for determining whether the reproduction start time comes, and
a reproduction controller for, when the determination is made that the reproduction start time comes, allowing the reproducing section to end the reproduction of the on-reproducing contents and start the reproduction of the contents data of the next contents in the reproduction start time.

7. A receiving apparatus connectable with a transmitting apparatus via a network, the transmitting apparatus transmitting contents data of same contents on a same reproducing position to each of receiving apparatuses at a same time, the receiving apparatus comprising:
a receiving section for receiving the contents data from the transmitting apparatus;
a reproducing section for reproducing the received contents data;
a time specifying section for specifying a reception start time at which contents data of next contents is received first;
a start time setting section for adding a delay time set to the same time in each of the receiving apparatuses to the reception start time, and setting a reproduction start time of next contents;
a time determining section for determining whether the reproduction start time comes; and
a reproduction controller for, when the determination is made that the reproduction start time comes, allowing the reproducing section to end the reproduction of the on-reproducing contents and start the reproduction of the contents data of the next contents in the reproduction start time.

8. The receiving apparatus according to claim 7, wherein
when the determination is made that the reproduction start time comes, the reproduction controller allows the reproducing section to delete all the contents data of the on-reproducing contents from a storage region and store the contents data of the next contents in the reproduction start time so as to start the reproduction of the contents data of the next contents in the reproduction start time.

9. The receiving apparatus according to claim 7, wherein
the reproducing section carries out synthesizing and reproduction so that an end portion of the previous contents is faded out and a head portion of the next content is faded in,
the start time setting section adds the delay time to the reception start time, and subtracts a residual reproduction time accumulated in the buffer at the time of first receiving the contents data of the next contents so as to set the reproduction start time.

10. The receiving apparatus according to claim 7, further has a residual reproduction time transmitting section for transmitting a residual reproduction time of the on-reproducing contents at a time when the determination is made that the reproduction start time comes to the transmitting apparatus, and
a delay time receiving section for receiving new delay time calculated by the transmitting apparatus base on the residual reproduction time, wherein
the start time setting section adds the calculated new delay time to the reception start time, and sets a reproduction start time of next contents.

11. The receiving apparatus according to claim 7, further has a difference information transmitting section for transmitting information about a difference between a reference clock received from the transmitting apparatus and a clock managed in each of the receiving apparatuses to the transmitting apparatus.

12. A receiving and reproducing program stored on a non-transitory computer readable medium causing a computer to perform as the receiving section, the reproducing section, the time specifying section, the start time setting section, the time determining section and the reproduction controller according to claim 7.

13. A receiving and reproducing method of a receiving apparatus, the receiving apparatus connectable with a transmitting apparatus for transmitting contents data of same contents on a same reproducing positions to each of receiving apparatuses at a same time via a network, the method comprising:
a step of receiving the contents data from the transmitting apparatus;
a step of reproducing the received contents data;
a step of specifying a reception start time at which contents data of next contents is received first;
a step of adding a delay time set to a same time in each of the receiving apparatuses to the reception start time and specifying a reproduction start time of next contents;
a step of determining whether the reproduction start time comes; and
a step of, when the determination is made that the reproduction start time comes, ending the reproduction of on-reproducing contents and starting the reproduction of the contents data of the next contents in the reproduction start time.

14. A transmitting apparatus connectable with a receiving apparatus via a network comprising:
a transmitting section for transmitting contents data of same contents on a same reproducing position to the receiving apparatus and the transmitting apparatus at a same time,
a receiving section for receiving the contents data from the transmitting apparatus,
a reproducing section for reproducing the received contents data,
a time specifying section for specifying a reception start time at which contents data of next contents is received first,
a start time setting section for adding a delay time set to the same time in each of the receiving apparatus and the transmitting apparatus to the reception start time so as to set a new reproduction start time of contents,
a time determining section for determining whether the reproduction start time comes, and
a reproduction controller for, when the determination is made that the reproduction start time comes, allowing the reproducing section to end the reproduction of the on-reproducing contents and start the reproduction of the contents data of the next contents in the reproduction start time.

15. A transmitting apparatus connectable with a plurality of receiving apparatuses via a network comprising:
a transmitting section for transmitting contents data of same contents on a same reproducing position to the respective receiving apparatuses at a same time,
a residual reproduction time receiving section for receiving residual reproduction times of the on-reproducing contents at a time when the determination is made that a reproduction start time comes from the respective receiving apparatuses,
a delay time calculator for specifying maximum value of the residual reproduction times received from the respective receiving apparatuses and adds the maximum value to a delay time so as to calculate new delay time, and
a delay time transmitting section for transmitting the calculated new delay time to the receiving apparatuses.

16. A transmitting apparatus connectable with a plurality of receiving apparatuses via a network comprising:
a transmitting section for transmitting contents data of same contents on a same reproducing position to the respective receiving apparatuses at a same time,
a difference information receiving section for receiving a difference information about a difference between a reference clock of the transmitting apparatus and a clock managed in each of the receiving apparatuses from each of the receiving apparatuses, and
a contents separating section for, when the received difference information is a predetermined value or more and an audio signal level is less than a predetermined level at which the audio signal is determined as silent, separating the contents as another contents on a portion where the audio signal level is less than the predetermined level.

17. A transmitting and reproducing program stored on a non-transitory computer readable medium causing a computer to perform as the transmitting section, the receiving section, the reproducing section, the time specifying section, the start time setting section, the time determining section and the reproduction controller according to claim 14.

18. A transmitting program stored on a non-transitory computer readable medium causing a computer to perform as the transmitting section, the residual reproduction time receiving section, the delay time calculator and the delay time transmitting section according to claim 15.

19. A transmitting program stored on a non-transitory computer readable medium causing a computer to perform as the transmitting section, the difference information receiving section and the contents separating section according to claim 16.
